(19) United States
(12) Patent Application Publication
(10) Pub. No.: US 2016/0378822 A1
(43) Pub. Date: Dec. 29, 2016

(54) AUTOMATED RECOMMENDATION AND CREATION OF DATABASE INDEX

(71) Applicant: Microsoft Technology Licensing, LLC, Redmond, WA (US)

(72) Inventors: Andrija Jovanovic, Belgrade (RS); Isidora Jovandic, Belgrade (RS); Milos Milovanovic, Belgrade (RS); Aleksandar Milovanovic, Sabac (RS); Iva Lazovic, Belgrade (RS); Vladimir Milosevic, Belgrade (RS); Vlajko Stojanovic, Belgrade (RS); Vladimir Ivanovic, Belgrade (RS); Sergei Patiakin, Beograd (RS); Anil Kumar Yelam, Belgrade (RS)

(21) Appl. No.: 14/752,620

(22) Filed: Jun. 26, 2015

(51) Int. Cl. G06F 17/30

(52) U.S. Cl. CPC G06F 17/30442; G06F 17/30321; G06F 17/30339; G06F 17/3051

(57) ABSTRACT

A system that automatically formulates recommendations or suggestions for creating indexes on database entities that will improve the overall query performance of a database and/or collection of databases for those queries that target a database entity for which index creation is recommended. A gathering module gathers at least a portion of historical data automatically generated by the database or database collection. An index recommendation module uses the gathered historical data to generate recommended indexing tasks on the basis of estimated greatest impact on overall query performance. An index creation module then initiates an indexing task of the generated set of one or more recommended indexing tasks to thereby create at least one corresponding index on at least one corresponding database entity to thereby improve overall query performance on the database or database collection.

### BACKGROUND

Computing systems and associated networks have revolutionized the way human beings work, play, and communicate. Nearly every aspect of our lives is affected in some way by computing systems. The proliferation of networks has allowed computing systems to share data and communicate, vastly increasing information access. For this reason, the present age is often referred to as the “information age”.

Databases allow some order to be imposed upon the vast world of information that is available. Rather than manually scan through all of the available data until the data of interest is found, queries may be issued to the database, allowing for retrieval of only the results of the query. To allow queries to be efficiently processed over one or more database entities (such as tables, views, and so forth) of one or more databases, the database entities are often indexed over one or more columns. The index essentially tells where data having parameters of particular values can be found. However, there are often a large variety of parameters represented within a database entities and/or a large number of possible database entities. Accordingly, indexing against all columns and values of all database entities becomes an infeasible task.

In order to improve performance of a database, databases are often “tuned”. Tuning a database involves adjusting various configurations and structures of the database so that the database responds more efficiently to the queries that tend to be submitted to the database. One aspect of such tuning involves creating indexes on particular columns on particular database entities.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to a system that automatically formulates recommendations or suggestions for creating indexes on database entities that will improve the overall query performance on a collection of one or more (and perhaps many) databases for those queries that target the newly indexed database entity. The system includes a gathering module that is configured to gather at least a portion of historical data automatically generated by the database collection. An index recommendation module is configured to use the historical data gathered by the gathering module to generate a set of one or more recommended indexing tasks on the basis of estimated greatest impact on collective performance of the database collection. Each recommended task is for indexing at least one database entity of the database collection.

An index creation module is configured to thereafter select and initiate an indexing task of the generated set of one or more recommended indexing tasks to thereby create at least one corresponding index on at least one corresponding database entity to thereby improve overall query performance on the database collection for queries that target that newly indexed database entity.

Accordingly, an efficient mechanism for substantially automating the tuning of even large collections of databases without requiring significant user time is described herein. The tuning is accomplished via the system recommending indexing tasks that are most likely to improve the performance of the collection of databases as a whole. The net result is substantial improvement of performance of the database collection through simplified user interface, thereby allowing to be achieved what would be virtually impossible if the user themselves had to investigate each database for possible tuning opportunities.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 abstractly illustrates a computing system in which some embodiments described herein may be employed;

FIG. 2 illustrates a system in which the automated formulation of index recommendations in the context of multiple databases may occur, and which includes a tuning portion that operates upon the database collection;

FIG. 3 illustrates addition information that is generated by the database collection of FIG. 2, which additional information is made available to the tuning portion of FIG. 2 and includes missing index data, query performance data, and private data;

FIG. 4 illustrates a flowchart of an example operation of the tuning portion of FIG. 2 in order to generate and display a set of one or more recommended tuning tasks to a user;

FIG. 5 abstractly illustrates an example set of recommended indexing tasks;

FIG. 6 abstractly illustrates a tuning portion that represents a specific example of the tuning portion of FIG. 2;

FIG. 7 abstractly illustrates an example data structure of a recommended indexing task, which may represent any of the indexing tasks of the set of recommended indexing tasks of FIG. 5;

FIG. 8 illustrates a flowchart of an example operation of the tuning portion of FIG. 2 in order to validate a created index; and

FIG. 9 illustrates a flowchart of a method for validating the creation of an index.

### DETAILED DESCRIPTION

At least some embodiments described herein relate to a system that automatically formulates recommendations or suggestions for creating indexes on database entities that will improve the overall query performance on a collection of one or more (and perhaps many) databases for those queries that target the newly indexed database entity. The system includes a gathering module that is configured to gather at least a portion of historical data automatically generated by the database collection. An index recommendation module is configured to use the historical data gathered by the gathering module to generate a set of one or more recommended indexing tasks on the basis of estimated greatest impact on collective performance of the database collection. Each recommended task is for indexing at least one database entity of the database collection.

An index creation module is configured to thereafter select and initiate an indexing task of the generated set of one or more recommended indexing tasks to thereby create at least one corresponding index on at least one corresponding database entity to thereby improve overall query performance on the database collection for queries that target that newly indexed database entity.

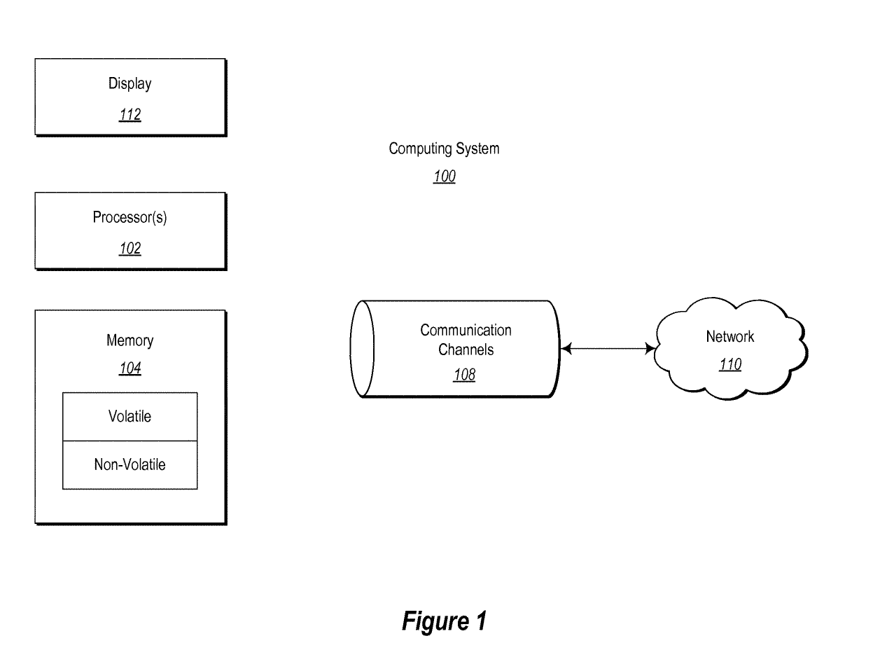

Accordingly, an efficient mechanism for substantially automating the tuning even large collections of databases without requiring significant user time is described herein. The tuning is accomplished via the system recommending indexing tasks that are most likely to improve the performance of the collection of databases as a whole. The net result is substantial improvement of performance of the database collection through simplified user interface, thereby allowing to be achieved what would be virtually impossible if the user themselves had to investigate each database for possible tuning opportunities. Some introductory discussion of a computing system will be described with respect to FIG. 1. Then, the automated formulation of index recommendations, the creation of such indices, and the validation thereof will be described with respect to subsequent drawings.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor to thereby provision the computing system for a special purpose. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “executable module” or “executable component” can refer to software objects, routines, or methods that may be executed on the computing system. The different components, modules, engines, and services described herein may be implemented as objects or processes that execute on the computing system (e.g., as separate threads). With such objects and processes operating upon the computing system, the computing system is the equivalent of a special purpose computer that functions for the special purpose accomplished by the objects.

In the description that follows, embodiments are described with reference to acts that are performed by one or more computing systems. If such acts are implemented in software, one or more processors (of the associated computing system that performs the act) direct the operation of the computing system in response to having executed computer-executable instructions, thereby converting and configuring the computing system for a more specialized purpose than without such direction. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other computing systems over, for example, network 110. The computing system 100 also includes a display 112, which may be used to display visual representations to a user.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. The computer executable instructions may be, for example, binaries or even instructions that undergo some translation (such as compilation) before direct execution by the processors, such as intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses, watches, and so forth) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

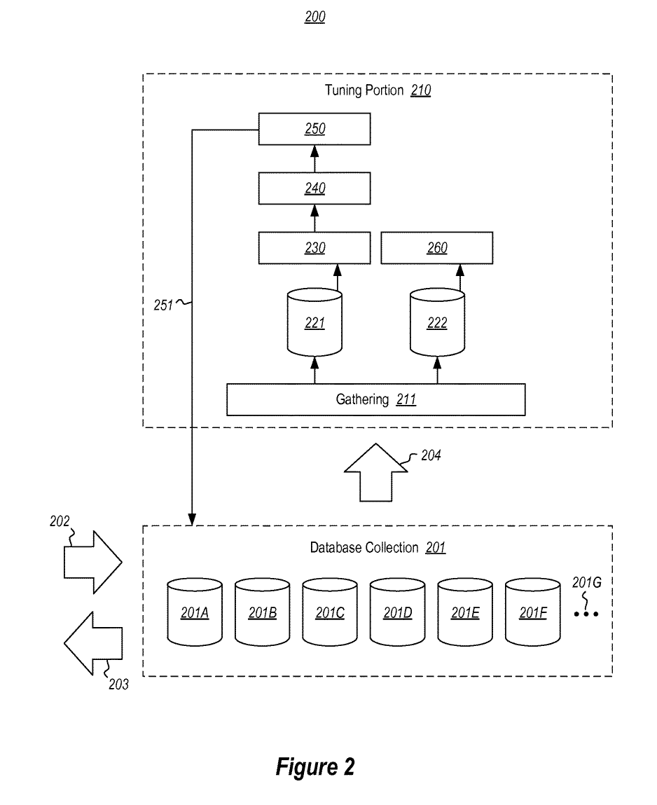

FIG. 2 illustrates a system 200 in which the automated formulation of index recommendations in the context of multiple databases may occur. The system 200 includes a collection 201 of databases. Queries may be submitted (as represented by arrow 202) that target one or more database entities of any, some, or all of the databases, and corresponding query results (as represented by arrow 203) are returned. In this description and in the claims, a “database” is broadly defined as any data store that may be queried against to obtain responses to the query. The database itself may contain structured data, unstructured data, semi-structured data, or combinations thereof.

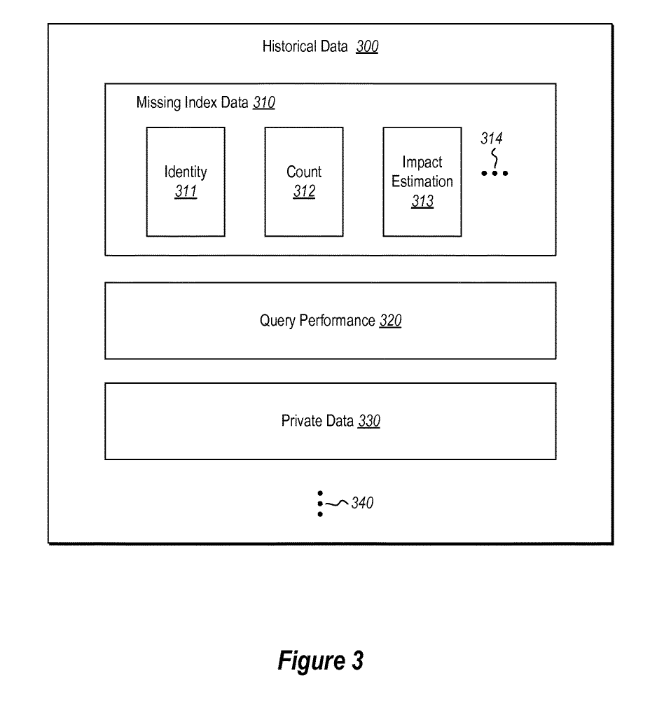

In addition to queries (represented by arrow 202) and responses (represented by arrow 203) thereto, each of the databases generates additional historical data (as represented by arrow 204). FIG. 3 illustrates such historical data 300 and includes missing index data 310, query performance data 320, and private data 330. Such information may be even gathered live such that the information is gathered as it is generated. Of course, the historical data 300 may include other information as well as represented by the ellipses 340. Such historical data 300 may be generated on a per-database or on a per-database entity basis. However, the aggregate of such historical data from all databases is represented abstractly by arrow 204 in FIG. 2.

Each database includes multiple and perhaps very many database entities, such as tables, views, and the like. Each database entity keeps track of which parameters it is indexed on. A database entity may be indexed on a parameter so that matching values of that parameter may be quickly found, whether useful for a final or intermediate result of the query. In conventional databases, a parameter corresponds to a column of a database entity, and thus conventional indexes of a database entity are indexed by column. However, the principles described herein are not limited to how a parameter of a database entity is indexed.

In one example, a system view is present for each database engine instance, and it is that system view that keeps track of what parameters it is indexed on. If a query is received that targets that database entity, and the query is against a particular parameter which is indexed on for that database entity, the parameter index may then be used to allow a response without fully scanning the database entity in full. However, if a query is received that causes the query engine to look for an index that is missing (i.e., a missing index), the database entity (e.g., the system view corresponding to each database engine) tracks that missing index, counts how many queries resulted in triggering of that missing index, and even estimates how much performance gain may be accomplished if the missing index (a hypothetical index) was provided. Such is collectively referred to herein as “missing index” data 310.

As examples only, the missing index data 310 includes identity information 311, count information 312, and impact estimation information 313, amongst potentially other information as represented by the ellipses 314. As an example, the missing index data 310 might include the following in the case of a SQL Server instance: sys.dm_db_missing_index_group_stats, sys.dm_db_missing_index_groups, and sys.dm_db_missing_index_details.

The identity information 311 represents an identity of the missing index that was triggered as a result of at least one prior query. The count information 312 represents a frequency or number of times that queries target each missing index. For instance, for a given missing index, the trigger information might include an average frequency at which the missing index is targeted, the number of times that the missing index has been targeted (in absolute terms and/or in a given time interval), and so forth. The impact estimation information 313 represents an estimated impact that having a hypothetical index (e.g., the missing index) would have on the queries that trigger the hypothetical index.

The query performance data 320 may include information regarding measured performance in the processing of queries. Such performance information might include, for instance, the following measurements for queries in general (or perhaps broken down by type of query), a number of processors cycles used to process queries, an amount of each type of resource used to process the queries, and so forth. Such information might include, for instance, group statistics (e.g., average, mean, median, extend, and so forth) for the queries. Such group statistics may be grouped over a period of time (such as perhaps a given time interval (e.g., in hours, days or the like). Thus, the query performance data 320 may include time-wise measurements of performance of queries in general, or types of queries.

The database collection 201 is illustrated as including six databases 201A through 201F. However, the ellipses 201G represent that the principles described herein may apply to any collection 201 of multiple databases from as few as two databases, to an unlimited number of databases. For instance, the collection 201 may be a cloud computing environment such as a public cloud, a private cloud, or a hybrid cloud that includes a public cloud and a private cloud (and/or an on-premises environment), and potentially include hundreds, thousands, or even millions of databases or more.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

The system 200 also includes a tuning portion 210 that serves to tune the database collection 201 to thereby improve the performance of the database collection. As an example, the tuning portion 210 recommends (or suggests) possible missing indexes that, if the corresponding index is created, might overall improve query performance on the database collection 201 to future queries that target the newly indexed database entity. Note that “overall” improved query performance does not mean that the performance of every query that targets the newly indexed database entity will be improved as a result of the created index. In fact, the index may potentially cause some of such queries to perform worse than without the index. However, overall improved query performance means that there tends to be more query improvement that there is query regression as a result of the created index for those queries that target the newly indexed database entity.

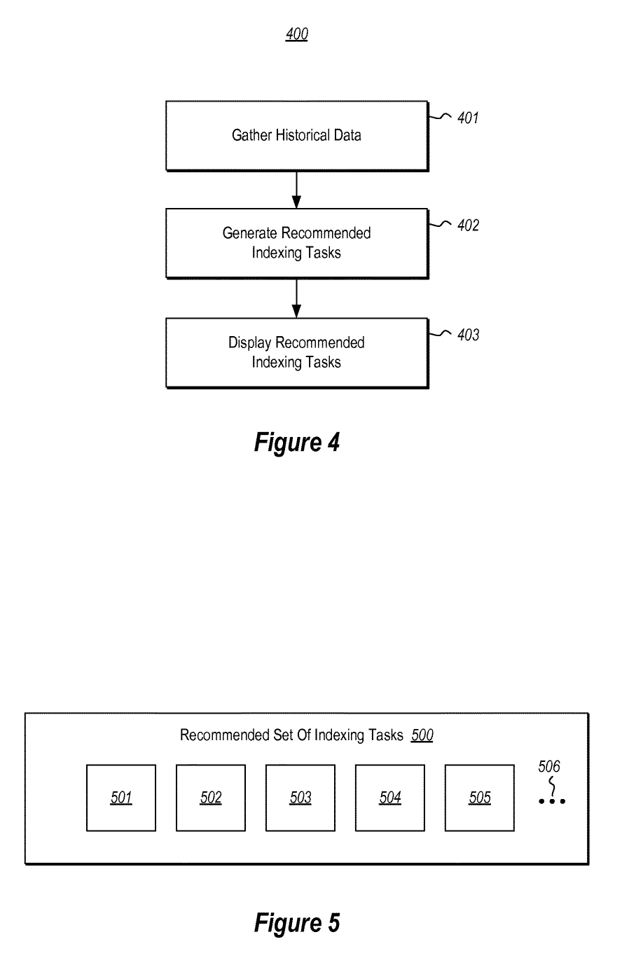

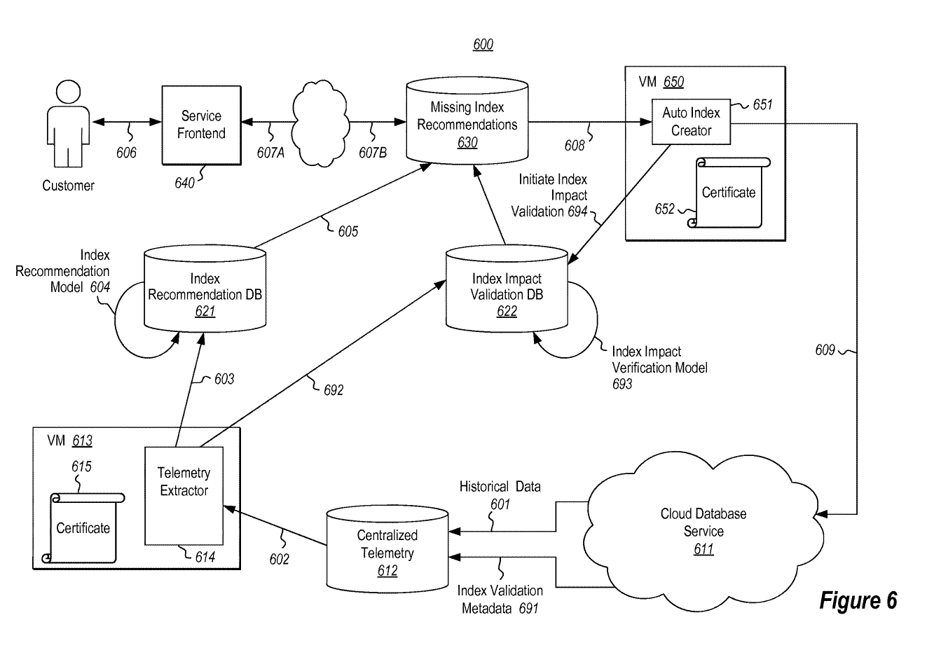

The operation of the tuning portion 210 will be described with respect to the method 400 of FIG. 4 and the method 800 of FIG. 8. Moreover, the tuning portion 600 of FIG. 6 represents a specific example of the tuning portion 210 of FIG. 2. Accordingly, the tuning portion 210 of FIG. 2 and its operation and example structure will be described with respect to FIGS. 2 through 9.

The tuning portion 210 includes a gathering module 211. FIG. 4 illustrates a flowchart of a method 400 for presenting tuning options to a user. The gathering module 211 is configured to gather at least a portion of the historical data (e.g., historical data 300 of FIG. 3) into a recommendation store 221 (act 401). The recommendation store 221 may be any type of store, such as a single database, or combination of databases, non-database storage, or any combination of the above. In one embodiment, the recommendation store 221 may be a single database.

The gathering module 211 is configured to apply a privacy policy such that private information (e.g., the private information 330 of FIG. 3) generated by the databases within historical information 300 is not gathered by the gathering module 211. Accordingly, the privacy of those making queries (e.g., queries 202) into the database collection 210 is preserved. For instance, the gathered information might include metadata associated with the queries, and not include the private data that is often included within the queries themselves. Such private data is customer sensitive data that is to be kept within a compliance boundary associated with the customer.

FIG. 6 illustrates a tuning portion 600 that represents an example of the tuning portion 210 of the system 200 of FIG. 2. A cloud database service 611 gathers all of the historical data generated by the databases (represented by arrow 204 in FIG. 2), and places such information into a telemetry database 612 (as represented by arrow 601). A virtual machine 613 thereafter uses a telemetry extractor module 614, with proper authentication provided by certificate 615, to access the centralized telemetry database 612 (as represented by arrow 602). The telemetry extractor 614 selects which historical data to then provide (as represented by arrow 603) to the index recommendation database 621. Thus, the cloud database service 611, the centralized telemetry database 612, and the virtual machine 613 of FIG. 3 are an example of the gathering module 211 of FIG. 2. Furthermore, the index recommendation database 621 of FIG. 6 is an example of the recommendation database 221 of FIG. 2. For instance, in a cloud computing environment, each node may have a dedicated process which periodically collects data from the specified views on that node and pushes the data to a centralized location for all telemetry in that corresponding region of a cloud database service. From all regional telemetry locations the data is automatically extracted to a single separate database. Thus, this centralized telemetry database 612 contains the missing index data and recommendations for all databases across the entire cloud database service.

The tuning portion 210 also includes an index recommendation module 230. The index recommendation module 230 is configured to use the historical data gathered by the gathering module to generate (act 402) a set of one or more recommended indexing tasks. The set of recommended indexing tasks may be based on estimated greatest impact on overall query performance on the collection of databases.

FIG. 6 illustrates an example of the index recommendation module 230 in the form of index recommendation module 604 which operates upon the gathered historical data within the index recommendation database 621, and provides (as represented by arrow 605) the set of recommended indexing tasks to a missing index recommendations database 630.

FIG. 5 abstractly illustrates an example set 500 of recommended indexing tasks. In this example, the set includes five indexing tasks as represented by tasks 501 through 505, although the ellipses 506 represents that there may be any number of indexing tasks included within the set 500.

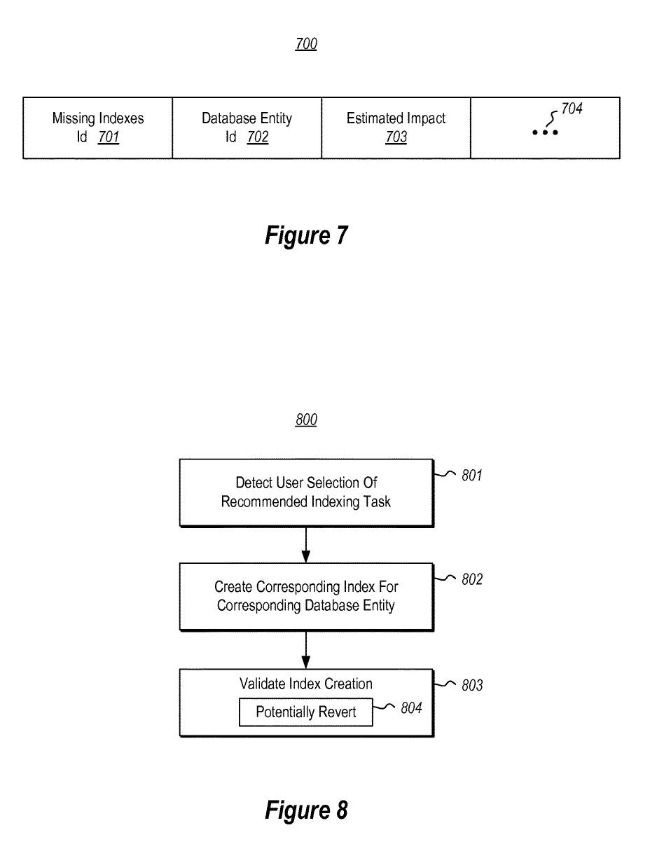

FIG. 7 abstractly illustrates an example recommended indexing task 700, which may represent any of the indexing tasks 501 through 505 of the set 500 of recommended indexing tasks of FIG. 5. The example recommended indexing task 700 includes a missing index identifier field 701, a corresponding database entity identifier field 702 identifying the corresponding database entity having the missing index, potentially the estimate impact field 703 of creating that missing index on that corresponding database entity, and potentially other fields 704 as well. In some embodiments, the recommended indexing tasks may be ranked on the basis of estimated greatest impact on collective performance on the database collection. For instance, perhaps task 501 has the highest estimated impact on collective performance.

An example of how the impact on overall query performance on the collection of databases may be calculated will now be described. Suppose that each missing index is identified by three pieces of data—equality columns, inequality columns and included columns. They represent columns used in equality comparisons, inequality/range scans and projections through SELECT statements, respectively. The query performance information gathered may include 1) UserSeeks, UserScans—which is the number of query executions that triggered the missing index recommendation; 2) AvgUserCost—the average cost (estimated by the optimizer) of each query that could be improved; and 3) AvgUserImpact—a value between 0 and 100 that estimates the amount (in optimizer units, as % of average cost) the queries would be improved by the index. In that case, the impact of creating the index (IndexAdvantage) may be calculated according to the following equation:

IndexAdvantage=(UserSeeks+UserScans)·AvgUserCost·AvgUserImpact

The index recommendation module 230 may be further configured to filter indexing tasks for each of at least some of missing indices identified in the gathered missing index data. For instance, perhaps the recommendation is too weak (the IndexAdvantage is too low), or is unreliable (e.g., changes frequently for different calculations), or is too stale. For recommendations which have multiple data points, a graph showcasing the IndexAdvantage over time may be used to filter out the relevant recommendations. A steeper positive slope of the graph may be factored in to strengthen the recommendation. The index recommendation module 230 may also be configured to merge a set of one or more recommended indexing tasks if the merged set can be fulfilled in a single indexing task.

The system 200 also includes an index control module 240 that displays the set of recommended indexing tasks to a user (act 403), such as a database collection administrator (e.g., a cloud administrator). For instance, in FIG. 6, the index control module 240 is within the service front end 640, which interfaces (as represented by arrow 606) with a user. The index control module 240 also permits a user to select a recommended indexing task provided by the index recommendation module, and that triggers creation of a corresponding index. For instance, in FIG. 6, arrow 606 may represent the display and selection process.

The system 200 also includes an index creation module 250. The index creation module 250 responds to a user selection of an indexing task of the generated set of one or more recommended indexing tasks by initiating creation of at least one corresponding index on at least one corresponding database. FIG. 8 illustrates a flowchart of a method 800 for creating a previous missing index to thereby improve query efficiency on the corresponding database and further improve the performance of the collective plurality of databases. The method 800 is triggered upon detecting that the user has selected an indexing task (act 801), whereupon the index creation module responds by initiating creation of at least one corresponding index on at least one corresponding database. This causes the corresponding index in the corresponding database to be created (act 802) as further represented by arrow 251 in FIG. 2. That said, in some embodiments, the user need not be involved at all. Accordingly, in FIG. 4, rather than display the recommended indexing tasks in act 403, the index recommendation module would simply output the recommended indexing task. Another computing module (rather than the user) may then select an appropriate recommended indexing task as part of act 801 in FIG. 8. Thus, method 400 of FIG. 4 might lead directly into method 800 of FIG. 8 in some embodiments.

For instance, in the case of user selection, referring to FIG. 6, the user (shown as “customer”) (or an computing module) may select one of the recommended indexing tasks displayed using the service front end 640, causing the control to trigger the virtual machine 650 into action. This triggering is represented in FIG. 6 by arrows 607A, 607B, and 608. The virtual machine 650 includes an auto index creator 651 that uses (as represented by arrow 609) the cloud database service 611 to create the corresponding index for the corresponding database. The virtual machine 650 also has a certificate 652 for purposes of secure authentication.

Although validation is not an integral part of the embodiments described herein, an example validation process will now be described. The system also includes a validation module 260 that operates upon a selected portion of additional information gathered by gathering module, to thereby validate (act 803) overall improved query performance on the collection of databases as a result of indices created by the index creation module for queries that target the respective newly indexed database entity. In some embodiments, the gathered information for the validation is the query performance data 320. This information may be present with an index validation database 222.

Referring to FIG. 6, the telemetry database 612 also includes index validation metadata (as represented by arrow 691), which is also provided (as represented by arrows 602 and 692) via the telemetry extractor 614 to the index validation database 622. Thus, the index impact validation database 622 of FIG. 6 is an example of the index validation database 222 of FIG. 2. Furthermore, the arrow 693 in FIG. 6 represents an index impact verification module that is an example of the validation module 260 of FIG. 2.

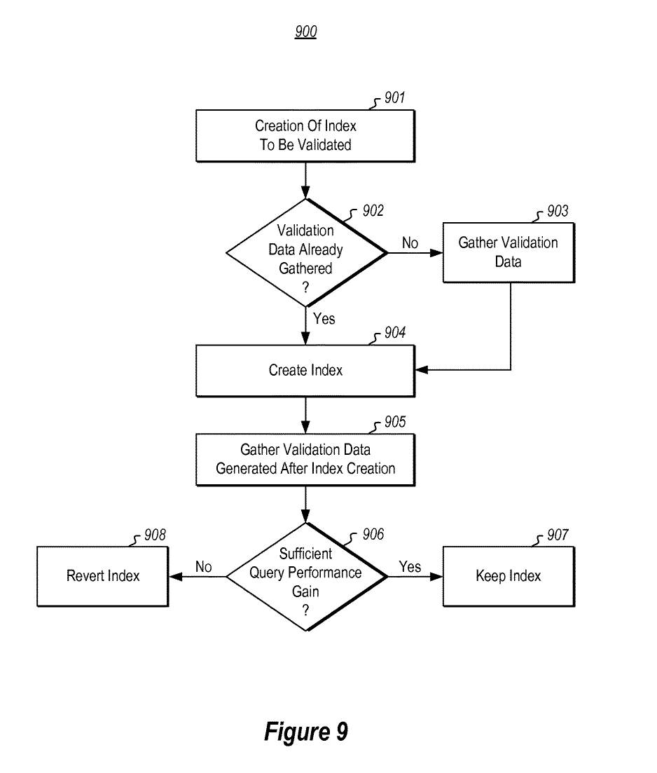

FIG. 9 illustrates a flowchart of a method 900 for validating the creation of an index. First, the validation module 260 determines that creation of the index is to be validated (act 901). (act 901). For instance, in FIG. 2, the index creation module 250 may signal the validation module 260 that the index creation is about to occur occurred. In FIG. 6, this is represented by the auto index creator 651 signaling (as represented by arrow 694) the index impact verification model 693.

The validation module 260 then determines whether validation data has already been gathered (decision block 902). If so (“Yes” in decision block 902), then validation data already exists that can be evaluated as a benchmark for the period prior to the creation of the index. Accordingly, the index may be created (act 904). If the validation data for the period prior to index creation has not yet been gathered (“No” in decision block 902), then the validation data is gathered (act 903) prior to the index being created (act 904).

In the case of having already gathered the validation data (“Yes” in decision block 902), the validation data may have been continuously gathered live as the validation data is generated, with perhaps older validation data being discarded. This scenario is helpful in that the index may be immediately created, but has the downside of having to expend processing, network, and storage resources regardless of whether an index is going to be created, and thus such resources might not ever be used. This scenario may be helpful, however, if indices are frequently being created on the database collection, thereby increasing the likelihood that such resources will be helpful in validating an index. In the case of deferring the gathering of the validation data (“No” in decision block 902) until it is determined (act 901) that an index is to be created, there is the advantage that processing, storage, and network resources are utilized only when needed to validate the index creation. However, the disadvantage is that there is some delay prior to the index creation being created.

Once the index is created (act 904), the validation data generated after the index creation is gathered (act 905). The validation data generated before and after the index creation are then evaluated (act 906) to be able to determine whether or not there has been a significant overall query performance gain as applied to the database collection for those queries that target the newly indexed database entity. If there has been a significant overall query performance gain (“Yes” in decision block 906), then the index is kept (act 907). If there has not been significant query performance gain (“No” in decision block 906), then the index is reverted (act 908). The validation module 260 may, for instance, perform this reversion. In one embodiment, the validation decision may be referred to as an index impact of the created index. The system 200 may include a reversion module 270 to perform such a reversion, or perhaps, the index creation module 250 may double as the reversion module. The validation module may alter the set of recommended indexing tasks as a result of the validation (as represented by arrow 695 in FIG. 6).

The system 200 also includes a validation control module that permits a user to control whether or not the validation module validates improved performance as a result of an index that the user caused to be created. For instance, in FIG. 6, the service front end 640 might also include such a validation control module.

Accordingly, what has been described is an efficient mechanism for substantially automating the tuning of large collections of databases without requiring significant user time. The tuning is accomplished via the system recommending indexing tasks that are most likely to improve the overall query on of the collection of databases as a whole. The net result is substantial improvement of performance of the database collection through simplified user interface, and allowing to be achieved what would be virtually impossible if the user themselves had to investigate each database for possible tuning opportunities.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system comprising:
a gathering module configured to gather at least a portion of historical data automatically generated by a plurality of databases;
an index recommendation module configured to use the historical data gathered by the gathering module to generate a set of one or more recommended indexing tasks on the basis of estimated greatest impact on collective performance of the plurality of databases, each recommended indexing task for indexing against at least one parameter of at least one of a plurality of database entities of the plurality of databases; and
an index creation module configured to initiate a recommended indexing task generated by the index recommendation module by creating at least one corresponding index on at least one corresponding database entity to thereby improve overall query performance on the collective plurality of databases for queries that target the database entity that is newly indexed as a result of the recommended indexing task.

2. The system in accordance with claim 1, the at least one corresponding database entity being a table.

3. The system in accordance with claim 1, the at least one corresponding database entity being a view.

4. The system in accordance with claim 1, further comprising
an index control module that permits a user to select the indexing task from the set of one of more recommended indexing tasks provided by the index recommendation module to thereby provided a recommended indexing task for the index creation module.

5. The system in accordance with claim 1, further comprising:
the collective plurality of databases.

6. The system in accordance with claim 1, the collective plurality of databases being a portion of a cloud computing environment.

7. The system in accordance with claim 6, the cloud computing environment being a public cloud.

8. The system in accordance with claim 6, the cloud computing environment being a private cloud.

9. The system in accordance with claim 6, the cloud computing environment being a hybrid cloud that includes a public cloud and at least one private cloud or on-premises environment.

10. The system in accordance with claim 1, further comprising:
a validation module configured to validate improved performance of at least one of the corresponding database entities and/or the collective plurality of databases as a result of indices created by the index creation module.

11. The system in accordance with claim 1, the plurality of databases comprising at least a million databases.

12. The system in accordance with claim 1, further comprising:
recommendation storage into which the gathering module stores the gathered historical data.

13. The system in accordance with claim 1, the historical data comprising at least missing index data representing at least missing indexes that were triggered by historical queries on the plurality of databases.

14. The system in accordance with claim 1, the gathered historical data comprising at least a portion of measured query performance data.

15. The system in accordance with claim 1, the gathered historical data including at least the following correlated to each of at least some of a plurality of missing indices identified by the historical data:
at least a portion of measured resource usage of each query that triggers the missing index.

16. The system in accordance with claim 1, the gathered historical data including at least the following correlated to each of at least some of a plurality of missing indices identified by the historical data:
at least a portion of an impact estimation representing an estimate of the impact that having a hypothetical index would have on the queries that trigger the hypothetical index.

17. The system in accordance with claim 1,
the index recommendation module configured to rank the set of one or more recommended indexing tasks on the basis of estimated greatest impact on collective performance on the plurality of databases.

18. The system in accordance with claim 17,
the index recommendation module configured filter indexing tasks for each of at least some of missing indices identified in the gathered missing index data.

19. The system in accordance with claim 1,
the index recommendation module also configured to merge a set of one or more recommended indexing tasks if the merged set can be fulfilled in a single indexing task.

20. A computer program product comprising one of more computer-readable storage media having thereon computer-executable instructions that are structured such that, when executed by one or more processors of the computing system, cause the computing system to instantiate and/or operate the following:
a gathering module configured to gather at least a portion of historical data automatically generated by a plurality of databases;
an index recommendation module configured to use the historical data gathered by the gathering module to generate a set of one or more recommended indexing tasks on the basis of estimated greatest impact on collective performance of the plurality of databases, each recommended indexing task for indexing against at least one parameter of at least one of a plurality of database entities of the plurality of databases; and
an index creation module configured to initiate a recommended indexing task generated by the index recommendation module by creating at least one corresponding index on at least one corresponding database entity to thereby improve overall query performance on the collective plurality of databases for queries that target the database entity that is newly indexed as a result of the recommended indexing task.

21. A method for improving performance of a collective plurality of databases, the method comprising:
an act of a gathering module gathering at least a portion of historical data automatically generated by a plurality of databases;
an act of an index recommendation module using the gathered historical data to generate a set of one or more recommended indexing tasks on the basis of estimated greatest impact on collective performance of the plurality of databases, each recommended indexing task for indexing against at least one parameter of a plurality of database entities of the plurality of databases; and
an act of an index creation module initiating a recommended indexing task of the generated set of one or more recommended indexing tasks by creating at least one corresponding index on at least one corresponding database entity for queries that target the database entity that is newly indexed as a result of the recommended indexing task.
